(19) United States
(12) Patent Application Publication
(10) Pub. No.: US 2020/0393483 A1
(43) Pub. Date: Dec. 17, 2020

(54) FLUID HANDLING DEVICE AND DIE

(71) Applicant: Enplas Corporation, Saitama (JP)

(72) Inventor: Koji NOGUCHI, Saitama (JP)

(73) Assignee: Enplas Corporation, Saitama (JP)

(21) Appl. No.: 16/970,966

(22) PCT Filed: Feb. 19, 2019
(86) PCT No.: PCT/JP2019/006032

§ 371 Date: Aug. 19, 2020

(30) Foreign Application Priority Data
Feb. 20, 2018 (JP) 2018-027892
Feb. 13, 2019 (JP) 2019-023314

(51) Int. Cl. G01N 35/10

(52) U.S. Cl. CPC G01N 35/1097

(57) ABSTRACT

A fluid handling device (100) has a case (110) and a containing section (120). The containing section (120) includes a side wall formed in a substantially circular cylindrical shape, a plurality of chambers, and a plurality of communication holes. The inner peripheral surface (131) of the case (110) includes: a plurality of divided inner peripheral surfaces (132) which surround a rotation axis (RA) and which each slope toward the rotation axis (RA) as the divided inner peripheral surface (132) extends toward the bottom of the case (110); and a step surface (133) disposed between two adjacent divided inner peripheral surfaces. At least part of the outer peripheral surface of the containing section (120) is in contact with the plurality of divided inner peripheral surfaces (132) of the case.

### TECHNICAL FIELD

The present invention includes a fluid handling device and a metal mold.

### BACKGROUND ART

In general, biological substances such as blood, protein, and DNA are analyzed through processes such as mixing with reagents, heating, cooling, and detection. In recent years, devices for successively performing such multiple processes are known (see, e.g., PTL 1).

PTL 1 discloses a multiple-chamber rotating valve (fluid handling device) including an insert (housing part) and a cartridge main body (case) that rotatably houses the insert. The insert includes a plurality of chambers formed inside. In the side wall of the insert, a plurality of through holes corresponding to the chambers are formed. In the side wall of the cartridge main body, an insertion port for insertion of a syringe is formed at a height corresponding to the through hole. Note that each chamber is filled with liquid of a reagent or a sample required for analysis in advance.

In the multiple-chamber rotating valve disclosed in PTL 1, a syringe is inserted from the insertion port to a first through hole corresponding to a first chamber, and a sample in the first chamber is suctioned into the syringe, for example. Next, the insert is rotated in the circumferential direction so as to align a second through hole corresponding to a second chamber with the insertion port, and the reagent in the second chamber is suctioned into the syringe. In this manner, the sample and the reagent are mixed in the syringe. In addition, when heating a mixture of the sample and the reagent, the mixture is heated by discharging the mixture in the syringe to a third chamber configured for heating so as to heat the multiple-chamber rotating valve with a heating apparatus and the like.

### CITATION LIST

### Patent Literature

### PTL 1

### Japanese Unexamined Patent Application Publication (Translation of PCT Application) No. 2012-522996

### SUMMARY OF INVENTION

### Technical Problem

The multiple-chamber rotating valve disclosed in PTL 1 is required to be replaced for each analysis, and as such is manufactured at low cost by injection molding with a resin material in some cases. In such a multiple-chamber rotating valve, accurate manufacturing is required in order to bring the outer peripheral surface of the insert and the inner peripheral surface of the cartridge main body into intimate contact with each other in view of preventing liquid leakage in operation. In this case, it is conceivable to correct the shapes of the outer peripheral surface of the insert and the inner peripheral surface of the cartridge main body by adjusting the corresponding surfaces of the metal mold corresponding to the outer peripheral surface of the insert and the inner peripheral surface of the cartridge main body.

However, in the multiple-chamber rotating valve disclosed in PTL 1, the inner peripheral surface of cartridge main body is composed of a single curved surface. Consequently, it is difficult to highly accuracy specify the position and the shape of the area where the shape should be corrected, and it is also difficult to adjust the corresponding surface of the metal mold. For this reason, for example, to correct the shape of a part of the inner peripheral surface of the cartridge main body, not only the corresponding surface corresponding to the part concerned, but also neighboring other surfaces that are not required to be adjusted have to be adjusted. Furthermore, even when only a part of the inner peripheral surface of the cartridge main body is corrected, the entirety of the corresponding surface may have to be corrected.

An object of the present invention is to provide a fluid handling device that enables easy and precise correction of the shape of the inner peripheral surface of the case. In addition, another object of the present invention is to provide a metal mold for molding the case of the fluid handling device.

### Solution to Problem

A fluid handling device of an embodiment of the present invention includes a case having a bottomed shape; and a housing part housed in the case such that an outer peripheral surface of the housing part is in contact with an inner peripheral surface of the case and that the housing part is rotatable around a rotational axis. The housing part includes a side wall formed in a substantially cylindrical shape, a plurality of chambers formed inside the side wall, and a plurality of communication holes configured to communicate between outside of the side wall and the plurality of chambers. The inner peripheral surface of the case includes a plurality of divisional inner peripheral surfaces surrounding the rotational axis, each of the plurality of divisional inner peripheral surfaces being tilted such that a distance to the rotational axis decreases in a direction toward a bottom of the case, and a step surface disposed between two divisional inner peripheral surfaces adjacent to each other of the plurality of divisional inner peripheral surfaces. At least a part of the outer peripheral surface of the housing part makes contact with at least one of the plurality of divisional inner peripheral surfaces of the case.

A metal mold of an embodiment of the present invention is configured to mold the case of the fluid handling device, the metal mold comprising a plurality of divisional pieces, each of the plurality of divisional pieces including a first metal mold surface configured to mold each of the plurality of divisional inner peripheral surfaces. The plurality of divisional pieces is stacked in a direction corresponding to the rotational axis. At least one of the plurality of divisional pieces includes a second metal mold surface configured to mold the step surface. In the plurality of divisional pieces, a divisional surface between a divisional piece including the second metal mold surface and a divisional piece adjacent to the divisional piece including the second metal mold surface is located on a same plane as the second metal mold surface.

### Advantageous Effects of Invention

The fluid handling device of an embodiment of the present invention can enable easy and precise correction of the shape of the inner peripheral surface of the case.

### BRIEF DESCRIPTION OF DRAWINGS

FIGS. 1A to 1D illustrate a configuration of a fluid handling device according to Embodiment 1;

FIGS. 2A to 2D illustrate a configuration of a case;

FIGS. 3A and 3B illustrate a configuration of the case;

FIGS. 4A to 4C illustrate a configuration of a housing part;

FIGS. 5A and 5B illustrate a configuration of a case in a fluid handling device according to Embodiment 2;

FIGS. 6A to 6D illustrate a configuration of a case in a fluid handling device according to Embodiment 3;

FIGS. 7A to 7D illustrate a configuration of a housing part in the fluid handling device according to Embodiment 3;

FIGS. 8A and 8B illustrate a configuration of a metal mold for molding the case; and FIGS. 9A and 9B illustrate a configuration of a fluid handling device according to Embodiment 4.

### DESCRIPTION OF EMBODIMENTS

A fluid handling device according to the present embodiment is described below with reference to the accompanying drawings.

### Embodiment 1

### Configuration of Fluid Handling Device

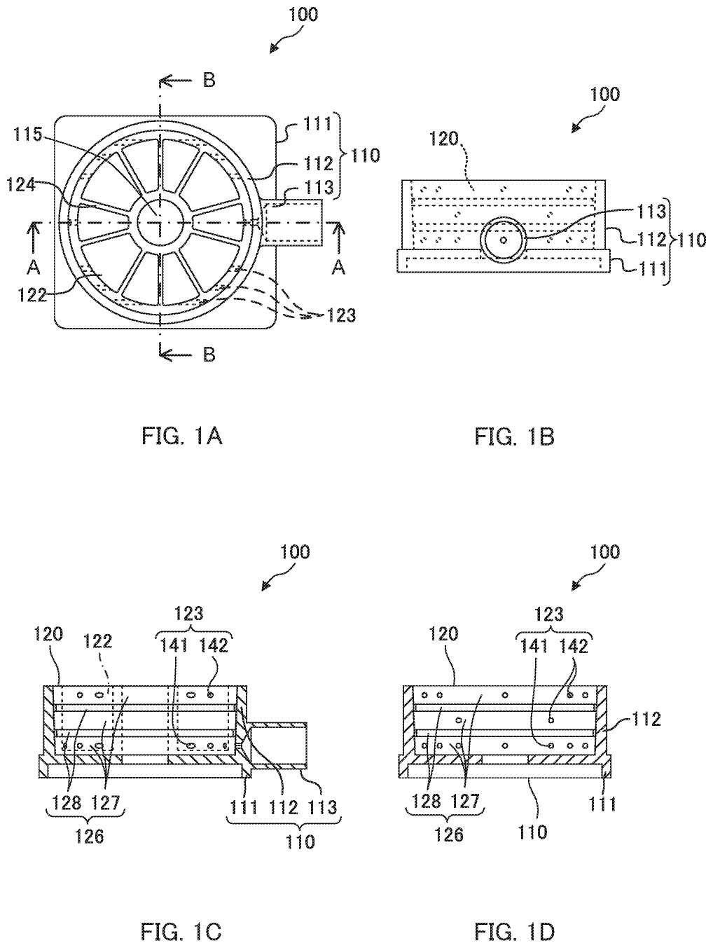

FIGS. 1A to 1D illustrate a configuration of fluid handling device 100. FIG. 1A is a plan view of fluid handling device 100, FIG. 1B is a right side view, FIG. 1C is a sectional view taken along line A-A of FIG. 1A, and FIG. 1D is a sectional view taken along line B-B of FIG. 1A. Note that FIGS. 1C and 1D are not cross-sectional views of housing part 120, but illustrate housing part 120 as viewed from a lateral side.

As illustrated in FIGS. 1A to 1D, fluid handling device 100 includes bottomed case 110 and housing part 120. Fluid handling device 100 is used in the state where housing part 120 is housed in case 110. In this state, at least a part of outer peripheral surface 126 of housing part 120 is in contact with a part (at least one of a plurality of divisional inner peripheral surfaces 132 described later) of inner peripheral surface 131 of case 110. Fluid handling device 100 is used for analyzing a detection object substance in a sample by operating fluid, including liquid and gas of a reagent, a sample and the like, with a syringe while intermittently rotating case 110 in sliding contact with housing part 120, for example.

Case 110 and housing part 120 are formed as separate members, and are assembled together to serve as fluid handling device 100. The manufacturing method for case 110 and housing part 120 is not limited. From a view point of the manufacturing cost, it is preferable to manufacture case 110 and housing part 120 by injection molding with a resin material. The material of case 110 and housing part 120 are not limited as long as the material has a resistance against the reagent used in the analysis, and the material is not deformed at the temperature during the analysis. Examples of the material of case 110 and housing part 120 include polypropylene (PP), thermoplastic polyurethane elastomer (TPU), and polycarbonate (PC).

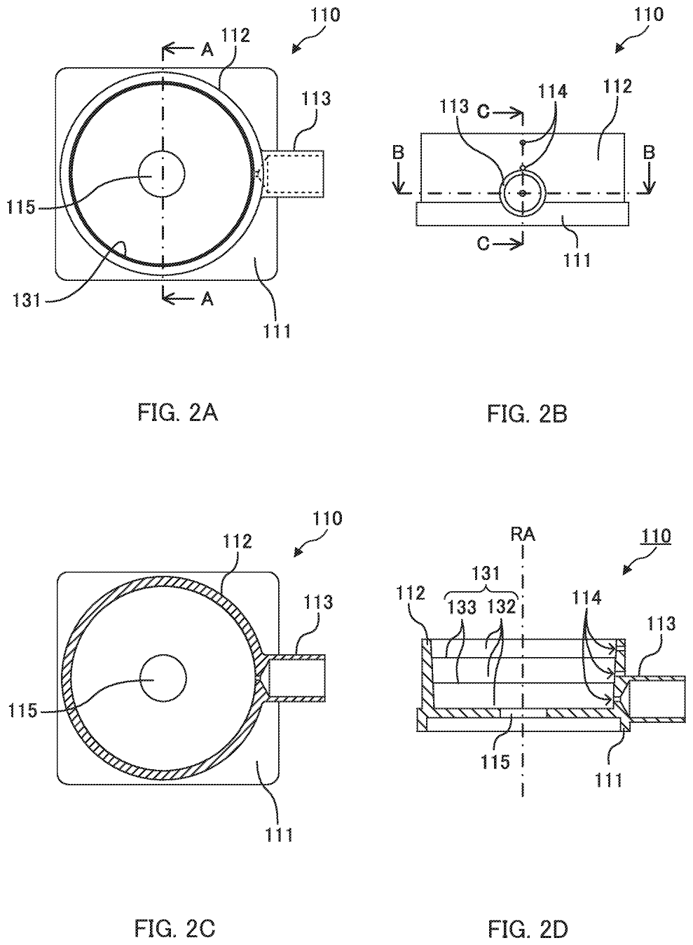

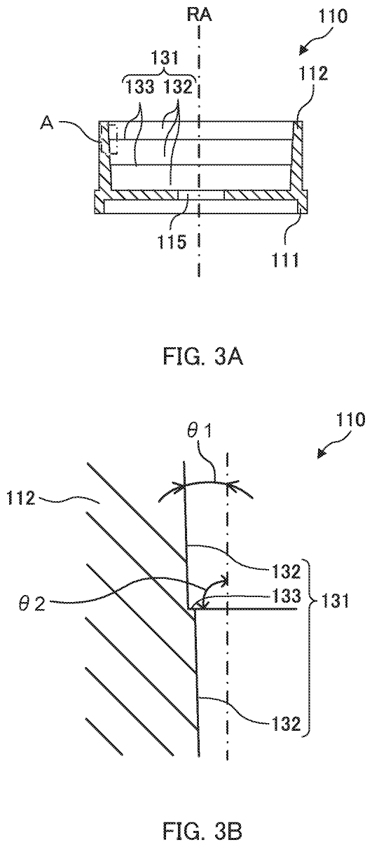

FIGS. 2A to 3B illustrate a configuration of case 110. FIG. 2A is a plan view of case 110, FIG. 2B is a right side view, FIG. 2C is a sectional view taken along line B-B of FIG. 2B, and FIG. 2D is a sectional view taken along line C-C of FIG. 2B. FIG. 3A is a sectional view taken along line A-A of FIG. 2A, and FIG. 3B is a partially enlarged sectional view of region A illustrated in FIG. 3A. The dashed line in FIG. 3B indicates a virtual line parallel to rotational axis RA.

As described above, case 110 rotatably houses housing part 120 around rotational axis RA. As illustrated in FIGS. 2A to 3B, case 110 includes base 111, case main body 112, insertion part 113, and outer communication hole 114.

Base 111 functions as an installation part for an external device such as a heating and cooling device as well as for installation of case main body 112. Case main body 112 is fixed at the upper portion of base 111. Hole 115 that opens at the front surface and the rear surface of base 111 is formed at a center portion of base 111.

Case main body 112 houses housing part 120 such that housing part 120 is rotatable around the rotational axis. Case main body 112 is formed in a cylindrical shape. In case main body 112, insertion part 113 for inserting a syringe, and outer communication hole 114 communicated with second communication hole 142 (described later) of housing part 120 are disposed.

Inner peripheral surface 131 of case main body 112 includes the plurality of divisional inner peripheral surfaces 132, and step surface 133. Inner peripheral surface 131 of case main body 112 is slightly tilted toward a center portion of the bottom of case 110 in its entirety.

Each divisional inner peripheral surface 132 is formed to surround rotational axis RA. In the state where housing part 120 is incorporated in case 110, the plurality of divisional inner peripheral surfaces 132 make contact with corresponding divisional outer peripheral surfaces 127 of housing part 120.

Each divisional inner peripheral surface 132 is tilted such that the distance to rotational axis RA decreases in the direction toward the bottom (base 111 side) of case 110. Inclination angle θ1 of divisional inner peripheral surface 132 to rotational axis RA is not limited. Inclination angle θ1 of divisional inner peripheral surface 132 to rotational axis RA is preferably approximately 1 to 3° from a viewpoint of the ease of assemble of case 110 and housing part 120, and from a viewpoint of prevention of extrusion of lubricant (e.g., grease) applied between case 110 and housing part 120. In the present embodiment, inclination angle θ1 of each divisional inner peripheral surface 132 to rotational axis RA is 2°.

The shape of divisional inner peripheral surface 132 in the cross section including rotational axis RA is preferably a linear shape from view points of the ease of measurement, robustness against errors, processing accuracy, processing difficulty and the like. Specifically, the shape of divisional inner peripheral surface 132 is preferably the shape of a side surface of an inverted truncated conical shape.

The number of divisional inner peripheral surfaces 132 is not limited as long as a plurality of divisional inner peripheral surfaces 132 is provided. Two or more divisional inner peripheral surfaces 132 may be provided. In the present embodiment, three divisional inner peripheral surfaces 132 are provided.

The length (height) of divisional inner peripheral surface 132 in the direction along rotational axis RA is preferably equal to or greater than the length (height) of divisional outer peripheral surface 127 in the direction along rotational axis RA. In the present embodiment, the length of divisional inner peripheral surface 132 located at the upper section (in FIG. 2D, the upper side in the drawing is the upper side) is equal to the length of corresponding divisional outer peripheral surface 127, and each of the other divisional inner peripheral surfaces 132 has a length greater than the length of divisional outer peripheral surface 127 in the direction along rotational axis RA.

Step surface 133 is disposed between two divisional inner peripheral surfaces 132 adjacent to each other to surround rotational axis RA. In the state where housing part 120 is incorporated in case 110, step surface 133 may be in contact with housing part 120, or separated from housing part 120. In the present embodiment, step surface 133 is in contact with housing part 120.

In the cross section including rotational axis RA, inclination angle θ2 of step surface 133 to rotational axis RA (angle θ2 between step surface 133 and rotational axis RA) is not limited as long as the angle is greater than inclination angle θ1 of two divisional inner peripheral surfaces 132 adjacent to each other, but it is preferable that the angle is an angle at which a clear ridgeline is formed between step surface 133 and two divisional inner peripheral surfaces 132 adjacent to each other. In the present embodiment, inclination angle θ2 of step surface 133 to rotational axis RA is 90° in the cross section including rotational axis RA. The ridgeline between step surface 133 and divisional inner peripheral surface 132 serves as a reference position for fine adjustment of a metal mold used for injection molding described later.

The length of step surface 133 in the direction along rotational axis RA is set in accordance with the length of divisional inner peripheral surface 132 in the direction along rotational axis RA.

One or more step surfaces 133 are provided, and the number of step surfaces 133 is set in accordance with the number of divisional inner peripheral surfaces 132. In the case where two divisional inner peripheral surfaces 132 are provided, one step surface 133 is provided, and in the case where three divisional inner peripheral surfaces 132 are provided, two step surfaces 133 are provided. In the present embodiment, three divisional inner peripheral surfaces 132 are provided, and accordingly two step surfaces 133 are provided. The number of step surfaces 133 is preferably smaller than the number of divisional inner peripheral surfaces 132 by one. That is, it is preferable that one step surface 133 is provided between two divisional inner peripheral surfaces 132.

Insertion part 113 is formed in a cylindrical shape. The shape of the inner surface of insertion part 113 is preferably a shape that is substantially complementary to the syringe. Insertion part 113 is configured such that an end of the syringe can be inserted to the inner opening of insertion part 113. The shape of the outer opening of insertion part 113 is a shape that is complementary to the external shape of the syringe. Insertion part 113 is formed at a position corresponding to first communication hole 141 (described later) formed in housing part 120.

Outer communication hole 114 is formed in case main body 112. Outer communication hole 114 is formed at a position corresponding to at least a part of second communication holes 142 (described later) formed in housing part 120. The number of outer communication holes 114 is not limited. In the present embodiment, case 110 includes one outer communication hole 114 formed at a height corresponding to the plurality of second communication holes 142 formed in divisional outer peripheral surface 127 located at the upper section, and one outer communication hole 114 formed at a height corresponding to a plurality of second communication holes 142 formed in divisional outer peripheral surface 127 located at the middle section. The two outer communication hole 114 are disposed along the direction along rotational axis RA.

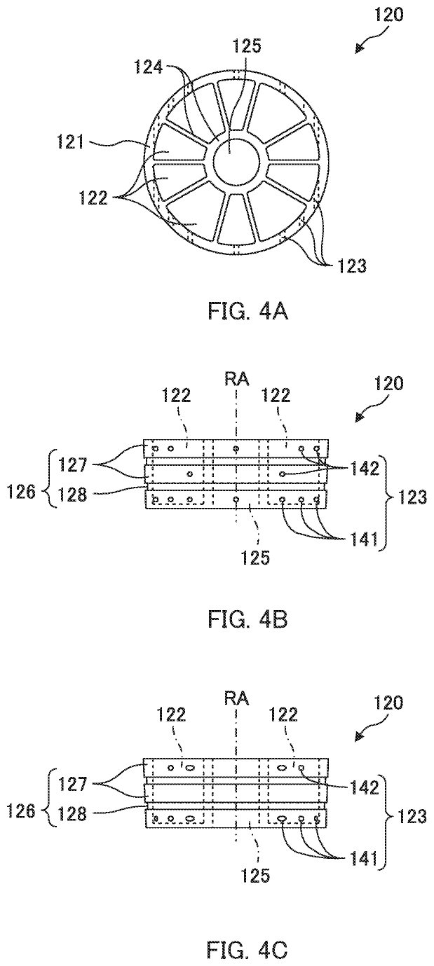

FIGS. 4A to 4C illustrate a configuration of housing part 120. FIG. 4A is a plan view of housing part 120, FIG. 4B is a front view, and FIG. 4C is a right side view.

Housing part 120 is housed such that housing part 120 in sliding contact with case 110 is rotatable around rotational axis RA. Housing part 120 has a substantially cylindrical shape with a closed bottom. In the direction perpendicular to rotational axis RA, housing part 120 has a circular external shape.

Housing part 120 includes substantially cylindrical side wall 121, a plurality of chambers 122 formed inside side wall 121, and a plurality of communication holes 123 that communicate between the outside of side wall 121 and chambers 122. The external shape of housing part 120 is defined by side wall 121. In addition, in housing part 120, the plurality of chambers 122 are defined by inner wall 124, and columnar inner hole 125 is defined by inner wall 124.

Outer peripheral surface 126 of side wall 121 includes a plurality of divisional outer peripheral surfaces 127, and a plurality of inner separation surfaces 128.

Each divisional outer peripheral surface 127 is formed to surround rotational axis RA. In the state where housing part 120 is incorporated in case 110, each the plurality of divisional outer peripheral surface 127 is in contact with divisional inner peripheral surface 132 of case 110. The length of divisional outer peripheral surface 127 in the direction along rotational axis RA is not limited as long as communication hole 123 can be open in a region in contact with divisional inner peripheral surface 132. In addition, the lengths of the plurality of divisional outer peripheral surfaces 127 in the direction along rotational axis RA may be equal to each other or different from each other. In the present embodiment, the length of divisional inner peripheral surface 132 located at the upper section (in FIGS. 4B and 4C, the upper side in the drawing is the upper side) is equal to the length of corresponding divisional outer peripheral surface 127, and the length of each of the other divisional inner peripheral surfaces 132 is greater than the length of divisional outer peripheral surface 127 in the direction along rotational axis RA.

Divisional outer peripheral surface 127 is tilted such that the distance to rotational axis RA decreases in the direction toward the bottom of case 110. The inclination angle of divisional outer peripheral surface 127 to rotational axis RA is preferably equal to the inclination angle of corresponding divisional inner peripheral surface 132 to rotational axis RA. The number of divisional outer peripheral surfaces 127 is preferably equal to the number of divisional inner peripheral surfaces 132. Communication hole 123 is open at least at a part of divisional outer peripheral surfaces 127.

Inner separation surface 128 is disposed to surround rotational axis RA between two divisional outer peripheral surfaces 127 adjacent to each other with the connection surface therebetween. In the state where housing part 120 is incorporated in case 110, inner separation surface 128 is not in contact with any surface of case 110. The length of inner separation surface 128 in the direction along rotational axis RA is set in accordance with the length of divisional outer peripheral surface 127. Inner separation surface 128 may be tilted with respect to rotational axis RA, or may be parallel to rotational axis RA.

One or more inner separation surfaces 128 are provided, and the number of inner separation surfaces 128 is set in accordance with the number of divisional outer peripheral surface 127. In the case where two divisional outer peripheral surfaces 127 are provided, one inner separation surface 128 is provided, and in the case where three divisional outer peripheral surfaces 127 are provided, two inner separation surfaces 128 are provided. In the present embodiment, three divisional outer peripheral surfaces 127 are provided, and accordingly two inner separation surfaces 128 are provided. The number of inner separation surfaces 128 is preferably smaller than the number of divisional outer peripheral surfaces 127 by one. That is, it is preferable that one inner separation surface 128 is disposed between two divisional outer peripheral surfaces 127.

Chambers 122 function also as reaction tanks for reaction of fluid such as liquid and gas of a sample or a reagent and the like while temporarily storing the fluid. The number of chambers 122 is not limited. The number of chambers 122 is appropriately set in accordance with the process required for analysis. In the present embodiment, ten chambers 122 are provided. The size of each chamber 122 is not limited. Chambers 122 may have the same size, or different sizes. In the present embodiment, the plurality of chambers 122 on the upper side in FIG. 4A, and the plurality of chambers 122 on the lower side in FIG. 4A respectively corresponding the plurality of chambers 122 on the upper side in FIG. 4A have the same shape. That is, in the present embodiment, the plurality of chambers 122 are formed to be symmetric about the cross section including rotational axis RA.

Communication holes 123 are formed in side wall 121. Communication hole 123 connects between the outside of side wall 121 and chamber 122. In the present embodiment, communication hole 123 has a linear shape. The number of communication holes 123 is not limited. The number of communication holes 123 is appropriately set in accordance with the specification of fluid handling device 100. Communication hole 123 includes first communication hole 141 and second communication hole 142.

First communication hole 141 is used for input and output of liquid at fluid chamber 122. In the present embodiment, a plurality of first communication holes 141 is formed in divisional outer peripheral surface 127 on the most bottom side. The number of first communication holes 141 is equal to the number of chambers 122.

Second communication hole 142 is used as an air hole and the like. In the present embodiment, a plurality of second communication holes 142 is formed in divisional outer peripheral surface 127 on the most opening side (upper section) and divisional outer peripheral surface 127 of the middle section. The number of second communication holes 142 is equal to the number of chambers 122.

Note that, although not illustrated in the drawings, housing part 120 may include a lid for closing at least a part of the opening of each chamber 122.

With fluid handling device 100, liquid in chamber 122 is suctioned through first communication hole 141 by inserting a syringe to insertion part 113, for example. At this time, second through hole 142 functions as an air hole. Next, housing part 120 is rotated around rotational axis RA with respect to case 110. Then, divisional inner peripheral surface 132 of case 110 makes contact with divisional outer peripheral surface 127 of housing part 120. Next, liquid in syringe is discharged into chamber 122. In this manner, in fluid handling device 100, the second through hole functions as an air hole when liquid is input to or output from chamber 122. In addition, divisional inner peripheral surface 132 of case 110 and divisional outer peripheral surface 127 of housing part 120 makes sliding contact with each other liquid leak does not occur.

### Effect

As described above, in fluid handling device 100 according to the present embodiment, inner peripheral surface 131 of case 110 is segmented into the plurality of divisional inner peripheral surfaces 132. In this manner, for example, even when correcting the shape of only divisional inner peripheral surface 132 located between the uppermost portion and the bottom during manufacture of case 110 by injection molding, it is possible to readily adjust only the corresponding surface of the metal mold corresponding to the divisional inner peripheral surface 132 concerned without adjusting the corresponding surface of the metal mold corresponding to the other divisional inner peripheral surfaces 132.

In addition, in a fluid handling device in which the inner peripheral surface of the case is composed of one inner peripheral surface rather than being segmented into a plurality of divisional inner peripheral surfaces, it is difficult to identify the location to be corrected, and consequently it is difficult to measure the specific dimension of the product (mold), thus resulting in a large measurement error in some cases. Likewise, when adjusting the metal mold, it is difficult to adjust only the targeted area since it is difficult to identify the targeted area, and thus a large error may occur. Further, when checking the size after the processing has been performed, it is difficult to perform specific measurement at the accurate position in some cases.

In contrast, in fluid handling device 100 according to the present embodiment, a clear ridgeline is formed between divisional inner peripheral surface 132 and step surface 133. As a result, the position of the area to be adjusted can be precisely determined with reference to the ridgeline, and the position of the area to be adjusted can be readily identified in the corresponding surface of the metal mold. Thus, with fluid handling device 100 according to the present embodiment, the shape of the inner peripheral surface of case 110 can be readily and precisely corrected.

In fluid handling device 100 according to the present embodiment, the shape of inner peripheral surface 131 of case 110 can be readily and precisely measured and corrected. As a result, the measurement, processing and manufacture of the product are further eased, and products can be more precisely manufactured in comparison with the conventional techniques. Thus, it is possible to achieve a product in which the degree of fit between case 110 and housing part 120 is improved, liquid leakage between case 110 and housing part 120 is suppressed, and rotation resistance is small. As a result, detection error is reduced, the rotational load on the driving part of the device, the product and the like is reduced.

### Embodiment 2

A fluid handling device according to Embodiment 2 differs from fluid handling device 100 according to Embodiment 1 only in configuration of inner peripheral surface 231 of case 210. Therefore, the components similar to those of fluid handling device 100 according to Embodiment 1 are denoted with the same reference numerals and the description thereof will be omitted.

### Configuration of Fluid Handling Device

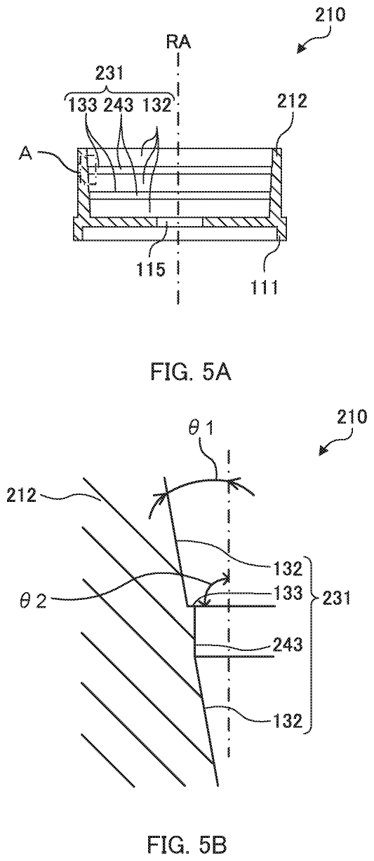

FIGS. 5A and 5B illustrate a configuration of case 210 in the fluid handling device according to Embodiment 2. FIG. 5A is a sectional view (corresponding to FIG. 3A) that includes rotational axis RA, but does not include insertion part 113, and FIG. 5B is a partially enlarged sectional view of region A illustrated in FIG. 5A. The dashed line in FIG. 5B indicates a virtual line parallel to rotational axis RA.

Fluid handling device includes case 210 and a housing part. As illustrated in FIGS. 5A and 5B, case 210 includes base 111, case main body 212, insertion part 113, and outer communication hole 114.

Inner peripheral surface 231 of case main body 212 further includes a plurality of outer separation surfaces 243 in addition to the plurality of divisional inner peripheral surfaces 132 and a plurality of the step surfaces 133. Outer separation surface 243 is disposed between the opening side end portion of divisional inner peripheral surface 132 and the inner end portion step surface 133. In the cross section including rotational axis RA, outer separation surface 243 has a linear shape. In addition, in the cross section including rotational axis RA, outer separation surface 243 may be tilted with respect to rotational axis RA, or may be parallel to rotational axis RA. In the present embodiment, outer separation surface 243 is parallel to rotational axis RA in the cross section including rotational axis RA. With this configuration, the boundary (ridgeline) between divisional inner peripheral surface 132 and outer separation surface 243 is appropriately molded.

### Effect

With the appropriately molded boundary (ridgeline) between divisional inner peripheral surface 132 and outer separation surface 243, the fluid handling device according to the present embodiment divisional can further clarify the reference position for fine adjustment of inner peripheral surface 132 while achieving the effect of fluid handling device 100 according to Embodiment 1.

### Embodiment 3

A fluid handling device according to Embodiment 3 differs from the fluid handling device according to Embodiment 2 only in configurations of inner peripheral surface 331 of case 310 and outer peripheral surface 326 of housing part 320. In view of this, the components similar to the fluid handling device according to Embodiment 2 are denoted with the same reference numerals and the description thereof will be omitted.

### Configuration of Fluid Handling Device

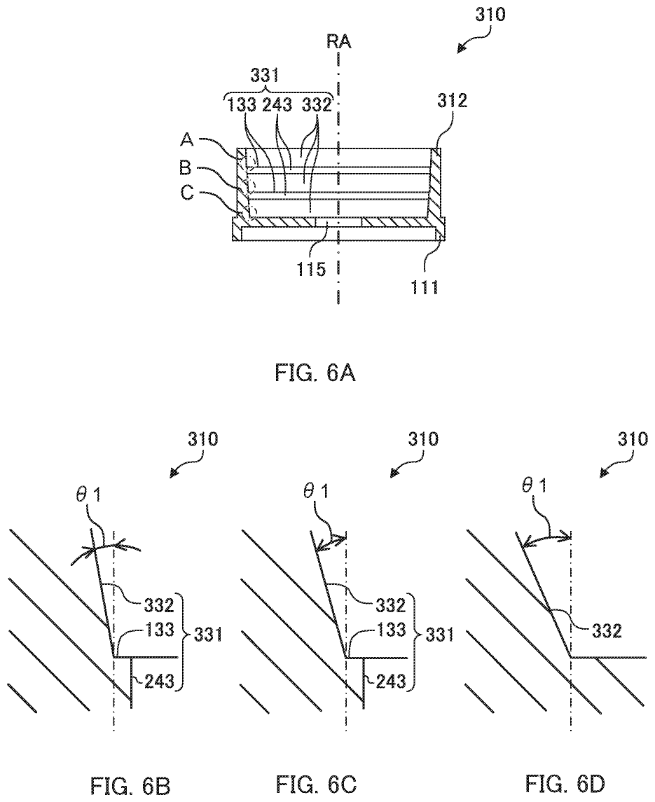

FIGS. 6A to 6D illustrate a configuration of case 310 in the fluid handling device according to Embodiment 3. FIG. 6A is a sectional view (corresponding to FIG. 3A) that includes rotational axis RA, but does not include insertion part 113, and FIGS. 6B to 6D are partially enlarged sectional views of regions A to C illustrated in FIG. 6A. The dashed line in FIG. 6 indicates a virtual line parallel to rotational axis RA.

Fluid handling device includes case 310 and housing part 320. As illustrated in FIG. 6A, case 310 includes base 111, case main body 312, insertion part 113, and outer communication hole 114.

As illustrated in FIGS. 6A to 6D, inner peripheral surface 331 of case main body 312 includes a plurality of divisional inner peripheral surfaces 332, step surface 133, and outer separation surface 243. The plurality of divisional inner peripheral surfaces 332 of the present embodiment have different inclination angles to rotational axis RA. In two divisional inner peripheral surfaces 332 adjacent to each other, inclination angle θ1 to rotational axis RA of divisional inner peripheral surface 332 on the bottom side is greater than inclination angle θ1 to rotational axis RA of divisional inner peripheral surface 332 of the opening side of case 310. As illustrated in FIGS. 6B to 6D, in the present embodiment, inclination angle θ1 of divisional inner peripheral surface 332 on the most opening side of case 310 to rotational axis RA is 1°, and inclination angle θ1 of divisional inner peripheral surface 332 on the most bottom side of case 310 to rotational axis RA is 3°, and, inclination angle θ of divisional inner peripheral surface 332 between divisional inner peripheral surface 332 having inclination angle θ1 of 1° and divisional inner peripheral surface 332 having inclination angle θ1 of 3° 1 is 2° with respect to rotational axis RA.

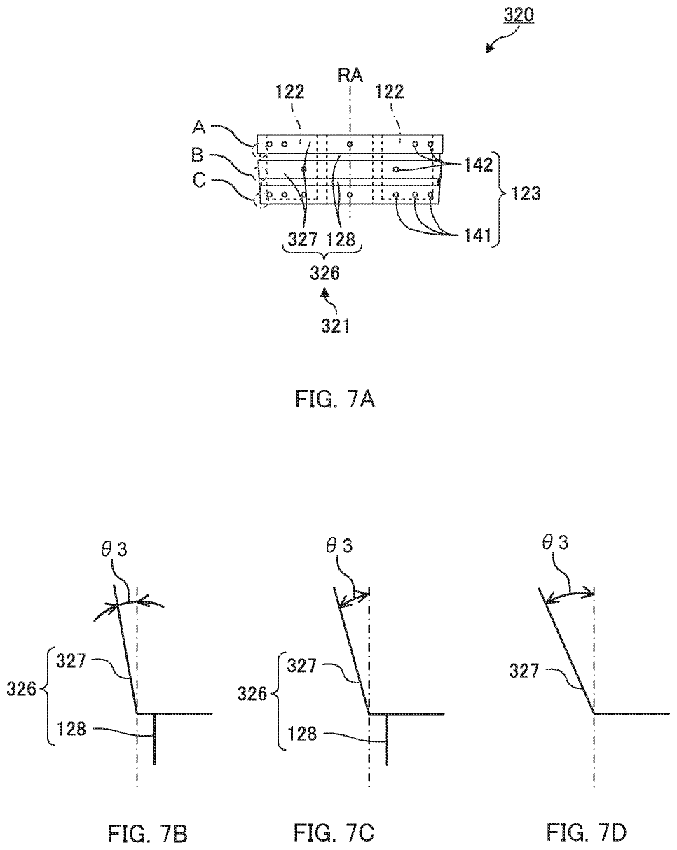

FIGS. 7A to 7D illustrate a configuration of housing part 320 in the fluid handling device according to Embodiment 3. FIG. 7A is a front view of housing part 320, and FIGS. 7B to 7D are partially enlarged sectional views of regions A to C illustrated in FIG. 7A. The dashed line in FIGS. 7B to 7D indicates a virtual line parallel to rotational axis RA.

As illustrated in FIG. 7A, housing part 320 includes side wall 321, the plurality of chambers 122, and the plurality of communication holes 123. Outer peripheral surface 326 of side wall 321 includes a plurality of divisional outer peripheral surfaces 327, and the plurality of inner separation surfaces 128.

In the present embodiment, inclination angle θ3 of the plurality of divisional outer peripheral surfaces 327 to rotational axis RA corresponds to the angle of divisional inner peripheral surface 332 to rotational axis RA. In two divisional outer peripheral surfaces 327 adjacent to each other, inclination angle θ3 of divisional outer peripheral surface 327 on the bottom side to rotational axis RA is greater than inclination angle θ3 of divisional outer peripheral surface 327 on the opening side of case 310 to rotational axis RA. As illustrated in FIGS. 7B to 7D, in the present embodiment, inclination angle θ3 of divisional outer peripheral surface 327 on the most opening side of case 310 to rotational axis RA is 1°, inclination angle θ3 of divisional outer peripheral surface 327 on the most bottom side of case 310 to rotational axis RA is 3°, and inclination angle θ3 of divisional outer peripheral surface 327 between divisional outer peripheral surface 327 having the inclination angle θ3 of 1° and divisional outer peripheral surface 327 having the inclination angle θ3 of 3° is 2° with respect to rotational axis RA.

### Effect

As described above, the fluid handling device according to the present embodiment ensures ease in adjustment of metal mold 500 for molding case 310 while achieving the effect of the fluid handling device according to Embodiment 2.

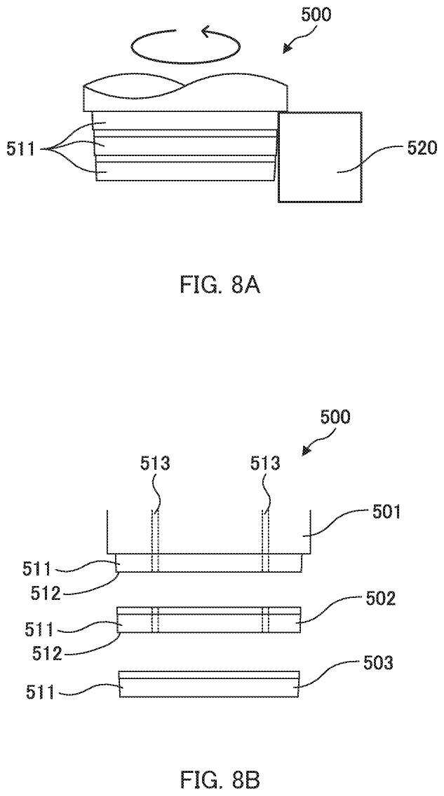

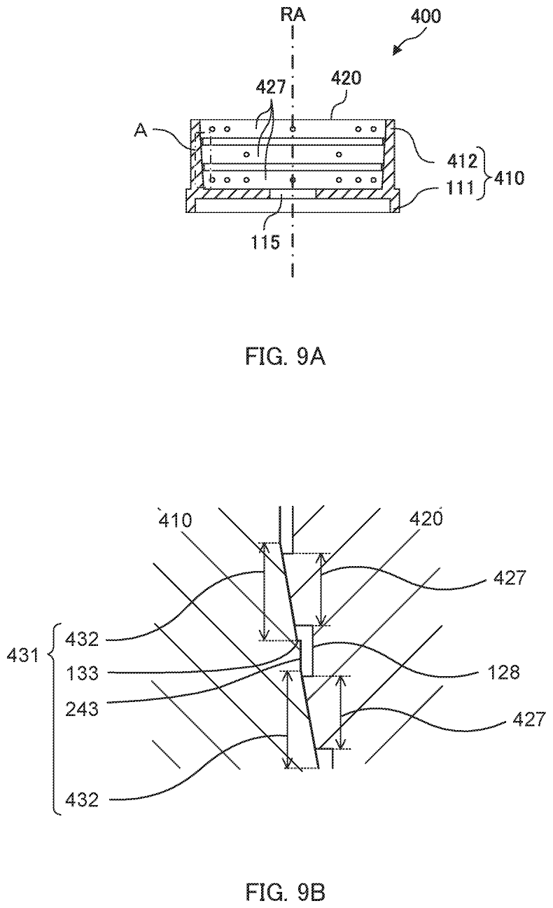

FIG. 8A describes an effect of Embodiment 3 and illustrates a configuration of metal mold 500 for molding case 310. In fine adjustment of first metal mold surface 511 for molding divisional inner peripheral surface 332 of metal mold 500, machining tool 520 (an end mill, a grindstone and the like) may be brought into contact with any first metal mold surface 511 while rotating metal mold 500 around rotational axis RA. As described above, in the fluid handling device according to the present embodiment, inclination angle θ1 of divisional inner peripheral surface 332 on the bottom side of case 310 to rotational axis RA is large. As a result, in fine adjustment of any first metal mold surface 511 corresponding to divisional inner peripheral surface 332, machining tool 520 does not make contact with other first metal mold surfaces 511. Thus, first metal mold surface 511 of metal mold 500 can be easily fine adjusted.

Note that, metal mold 500 for molding the plurality of divisional inner peripheral surfaces 332 of case 310 may be composed of a plurality of divisional pieces 501, 502 and 503. FIG. 8B is an exploded view illustrating a configuration of metal mold 500 composed of the plurality of divisional pieces 501, 502 and 503.

As illustrated in FIG. 8B, each of divisional pieces 501, 502 and 503 includes first metal mold surface 511 for molding divisional inner peripheral surface 332, and, when in use, they are stacked in the direction corresponding to rotational axis RA. In addition, in the plurality of divisional pieces 501, 502 and 503, each of divisional pieces 501 and 502 includes second metal mold surface 512 for molding step surface 133. The divisional surface between divisional piece 501 and divisional piece 502 is located on the same plane as second metal mold surface 512 of divisional piece 501. Likewise, the divisional surface between divisional piece 502 and divisional piece 503 is located on the same plane as second metal mold surface 512 of divisional piece 502. In addition, degassing hole 513 for connection to the divisional surface is formed in divisional pieces 501 and 502. With metal mold 500 composed of divisional pieces 501, 502 and 503, first metal mold surface 511 for molding divisional inner peripheral surface 332 can be individually adjusted. In addition, degassing can be efficiently performed through the divisional surface during the molding. As a result, productivity is improved while improving the molding quality, and thus manufacture cost can be reduced.

### Embodiment 4

A fluid handling device according to Embodiment 4 differs from the fluid handling device according to Embodiment 2 only in the relationship of the sizes of divisional inner peripheral surface 432 of case 410 and divisional outer peripheral surface 427 of housing part 420. In view of this, the components similar to those of the fluid handling device according to Embodiment 2 are denoted with the same reference numerals and the description thereof will be omitted.

### Configuration of Fluid Handling Device

FIGS. 9A and 9B illustrate a configuration of a fluid handling device according to Embodiment 4. FIG. 9A is a sectional view of fluid handling device 400 taken along a cross-section that includes rotational axis RA but does not include insertion part 113. FIG. 9B is a schematic partially enlarged sectional view for describing a relationship of the sizes of divisional inner peripheral surface 432 and divisional outer peripheral surface 427. Note that FIG. 9 is not a cross-sectional view of housing part 420, but illustrates housing part 420 as viewed from a lateral side.

As illustrated in FIGS. 9A and 9B, fluid handling device 400 includes case 410 and housing part 420. Case 410 includes base 111, case main body 412, insertion part 113, and outer communication hole 114.

Inner peripheral surface 431 of case main body 412 includes a plurality of divisional inner peripheral surfaces 432, step surface 133, and outer separation surface 243. In the present embodiment, the opening side end portion of divisional inner peripheral surface 432 is disposed on the opening side relative to the opening side end portion of divisional outer peripheral surface 427 that makes contact with divisional inner peripheral surface 432, and the bottom side end portion of divisional inner peripheral surface 432 is disposed on the bottom side relative to the bottom side end portion of divisional outer peripheral surface 427 that makes contact with divisional inner peripheral surface 432. The size of divisional inner peripheral surface 432 with respect to divisional outer peripheral surface 427 is not limited. The size of divisional inner peripheral surface 432 with respect to divisional outer peripheral surface 427 is preferably set to a value that can allow for manufacturing errors. With this configuration, case 410 and housing part 420 can be appropriately assembled, and manufacturability can be increased.

### Effect

As described above, the fluid handling device according to the present embodiment can increase the manufacturability while achieving the effect of the fluid handling device according to Embodiment 2.

This application is entitled to and claims the benefit of Japanese Patent Application No. 2018-027892 filed on Feb. 20, 2018, and Japanese patent application No. 2019-023314 filed on Feb. 13, 2019, the disclosure each of which including the specification, drawings and abstract is incorporated herein by reference in its entirety.

### INDUSTRIAL APPLICABILITY

The fluid handling device of the embodiment of the present invention is applicable to analysis of minute amounts of biological samples, etc., for example.

### REFERENCE SIGNS LIST

100, 400 Fluid handling device
110, 210, 310, 410 Case
111 Base
112, 212, 312, 412 Case main body
113 Insertion part
114 Outer communication hole
115 Hole
120, 320, 420 Housing part
121, 321 Side wall
122 Chamber
123 Communication hole
124 Inner wall
125 Inner hole
126, 326 Outer peripheral surface
127, 327, 427 Divisional outer peripheral surface
128 Inner separation surface
131 231, 331, 431 Inner peripheral surface
132, 332, 432 Divisional inner peripheral surface
133 Step surface
141 First communication hole
142 Second communication hole
243 Outer separation surface
500 Metal mold
511 First metal mold surface
512 Second metal mold surface
520 Machining tool

1. A fluid handling device comprising:
a case having a bottomed shape; and
a housing part housed in the case such that an outer peripheral surface of the housing part is in contact with an inner peripheral surface of the case and that the housing part is rotatable around a rotational axis,
wherein the housing part includes
a side wall formed in a substantially cylindrical shape,
a plurality of chambers formed inside the side wall, and
a plurality of communication holes configured to communicate between outside of the side wall and the plurality of chambers,
wherein the inner peripheral surface of the case includes
a plurality of divisional inner peripheral surfaces surrounding the rotational axis, each of the plurality of divisional inner peripheral surfaces being tilted such that a distance to the rotational axis decreases in a direction toward a bottom of the case, and
a step surface disposed between two divisional inner peripheral surfaces adjacent to each other of the plurality of divisional inner peripheral surfaces, and
wherein at least a part of the outer peripheral surface of the housing part makes contact with at least one of the plurality of divisional inner peripheral surfaces of the case.

2. The fluid handling device according to claim 1, wherein the inner peripheral surface of the case further includes an outer separation surface spaced away from the outer peripheral surface of the housing part and located between the step surface and one of the plurality of divisional inner peripheral surfaces, the one of the plurality of divisional inner peripheral surfaces being adjacent to the step surface and located on a bottom side of the case relative to the step surface.

3. The fluid handling device according to claim 2, wherein in a cross section including the rotational axis, the outer separation surface is parallel to the rotational axis.

4. The fluid handling device according to claim 1, wherein in two divisional inner peripheral surfaces adjacent to each other of the plurality of divisional inner peripheral surfaces, an inclination angle to the rotational axis of one of the two divisional inner peripheral surfaces on a bottom side of the case is greater than an inclination angle to the rotational axis of the other of the two divisional inner peripheral surfaces on an opening side of the case.

5. The fluid handling device according to claim 1,
wherein the outer peripheral surface of the housing part includes
a plurality of divisional outer peripheral surfaces surrounding the rotational axis and tilted such that a distance to the rotational axis decreases in the direction toward the bottom of the case, the plurality of divisional outer peripheral surfaces being configured to make contact with the plurality of divisional inner peripheral surfaces; and
an inner separation surface spaced away from the plurality of divisional inner peripheral surfaces of the case, the inner separation surface being located between two divisional outer peripheral surfaces adjacent to each other of the plurality of divisional outer peripheral surfaces, and
wherein the plurality of communication holes is open at least at one of the plurality of divisional outer peripheral surfaces.

6. The fluid handling device according to claim 5,
wherein in each of the plurality of divisional inner peripheral surfaces,
an end portion on an opening side of the case of the each of the plurality of divisional inner peripheral surfaces is disposed on the opening side relative to an end portion on the opening side of a divisional outer peripheral surface of the plurality of divisional outer peripheral surfaces that makes contact with the each of the plurality of divisional inner peripheral surfaces, and
an end portion on a bottom side of the case of the each of the plurality of divisional inner peripheral surfaces is disposed on the bottom side relative to an end portion on the bottom side of the divisional outer peripheral surface that makes contact with the each of the plurality of divisional inner peripheral surfaces.

7. A metal mold configured to mold the case of the fluid handling device according to claim 1, the metal mold comprising a plurality of divisional pieces, each of the plurality of divisional pieces including a first metal mold surface configured to mold each of the plurality of divisional inner peripheral surfaces,
wherein the plurality of divisional pieces is stacked in a direction corresponding to the rotational axis;
wherein at least one of the plurality of divisional pieces includes a second metal mold surface configured to mold the step surface; and
wherein in the plurality of divisional pieces, a divisional surface between a divisional piece including the second metal mold surface and a divisional piece adjacent to the divisional piece including the second metal mold surface is located on a same plane as the second metal mold surface.
